(19) United States
(12) Patent Application Publication
(10) Pub. No.: US 2017/0228916 A1
(43) Pub. Date: Aug. 10, 2017

(54) SYSTEM AND METHOD FOR AN ENHANCED, MULTIPLAYER MIXED REALITY EXPERIENCE

(71) Applicant: Paperclip Productions, Inc., Los Angeles, CA (US)

(72) Inventors: Shawn Patrick, Santa Fe, NM (US); Dan Kikinis, Los Altos, CA (US)

(21) Appl. No.: 15/408,398

(22) Filed: Jan. 17, 2017

Related U.S. Application Data
(60) Provisional application No. 62/280,097, filed on Jan. 18, 2016.

(51) Int. Cl. G06T 15/00; G06T 19/00

(52) U.S. Cl. CPC G06T 15/005; G06T 19/006; G06T 2219/024

(57) ABSTRACT

A system for enhanced, multiplayer mixed reality experience has been developed. A high-speed video content rendering engine retrieves mixed reality content data from a plurality of sources. A high-speed, low latency memory map is then rendered. All or point of view specific sub-portions of this main memory map are then transmitted either to secondary servers of lesser capability, which drive one to three mixed reality goggles or up to ten or more of virtual reality goggles directly. User experience may be enhanced the system providing physical props, sounds or actions based upon clues contained in the mixed reality content data.

### CROSS-REFERENCE TO RELATED APPLICATIONS

This application claims the benefit of and priority to U.S. provisional patent application Ser. No. 62/280,097, titled “SYSTEM AND METHOD FOR AN ENHANCED, MULTIPLAYER VIRTUAL REALITY EXPERIENCE”, filed on Jan. 18, 2016, the entire specification of which is incorporated herein by reference.

### BACKGROUND OF THE INVENTION

### Field of the Invention

The present invention is in the field of enhanced, augmented or virtual reality systems, taken collectively as mixed reality systems herein. Specifically, the use of high-speed servers including high-speed, high-memory video subsystems to drive low latency, high framerate mixed reality, augmented reality or mixed reality experiences for multiple concurrent participants.

### Discussion of the State of the Art

For interactive entertainment systems, current limitations are the number of goggles that a system can concurrently support at very high frame rate and low inter-ocular latency, because lower frame rates and greater latency tend to induce nausea in users. Supporting more than two, or at the most three, sets of goggles in a single interactive entertainment session using the current approach typically pushes current rendering engines to their memory bandwidth limits. Another limitation is the risk of injury. Users may become disoriented due to the continuous bending of virtual space, leading them to fall unexpectedly. Yet another limitation is the lack of “real world implements” in virtual worlds to give the experience a more authentic feeling.

What is needed is a system and method for driving the operation of a high number of virtual reality(VR), augmented reality(AR) or mixed reality(MR) goggles in a single interactive entertainment session by concurrently supporting at very high frame rate and low latency, delivering a low/no nausea user experience. Further, what is needed is a system and method that may detect the imminent fall of a VR/AR/MR participant and safely prevent that occurrence. Also needed is a system and method to further enhance the VR/AR/MR experience by providing real-world prop implements during the course of a VR/AR/MR session.

### SUMMARY OF THE INVENTION

Accordingly, the inventor has developed a system and method for an enhanced, multiplayer mixed reality experience. This system may make use of one or more tightly networked servers equipped with ultra-high-speed video rendering hardware possessing high memory allotments such that a large, rapidly rendered memory map of an entire VR/AR/MR landscape, potentially encompassing the binocular data for several goggle displays may be constructed at high frame rate and very low latency and the system may then parcel out point-of-view sub-maps to controllers served by the main server that may consist of rendering engines with previously described memory bandwidth limits, for display by individual or small groups of goggles.

A harness that may follow a user and stop or limit the severity of a fall may greatly reduce or eliminate the risk of injury to users. The same mechanism that enables the harness to follow the user may also be used to present the user with “real world implements” in virtual worlds. For example, dangling the end of a rope from a virtual helicopter above, creating a locatable noise and/or a downdraft from said virtual helicopter, or rain, or water drops from a water fall above, etc. may all give the experience a more authentic feeling and/or a more enjoyable interaction.

The system and method disclosed herein offers users, referred to as players and/or observers, enhanced interactive mixed reality experiences. Players may experience an extension of a known audio/video storyline such as, for example, a movie, in a mix of a standard interactive experience in a panic room type of environment with an extension beyond that limited environment that offers a video game type of experience. This enhanced mixed reality is enabled through a mix of virtual reality and physical reality: scripted, interactive experiences wherein player interaction and cooperation may be required to complete the story. This approach incorporates player mechanics, 3-D reality printers, enhanced (or augmented) virtual 3-D reality with no-noticeable lag design of common core renderings and separate renderings, and semi-interactions with physical ends of virtual objects. It may include sensors, a virtual reality device, and an application that checks players into games, provides access to clues, controls the game level and a continuous experience outside the game, and supplies such accessories as leaderboards, etc.

In some cases, a system may create a virtual reality experience for multiple users at a very high frame rate with low latency, so the frame rate exceeds the capacity of a single display adapter memory bandwidth. Said system may have a main memory for all participants that may pre-render their views with minimal processing and parcel out subsets to memory systems of individual display adapters that each serve only a limited number of users. Further, the pre-rendering and copying is performed simultaneously so as to remove an additional step. Those individual adapters may then separately process the views of that limited number of users with low latency, so the total latency of the two stages does not exceed the desired maximum to avoid nausea by the users.

In yet other cases, a system for mixed reality may provide a harness positioned and secured to be able to follow the movements of a user in at least two ranges of motion laterally. This harness may be designed to lock up a cable secured to the user when one or more of at least two triggers are satisfied that the person is falling or is about to fall. Such triggers may be an accelerometer of a pulley system connecting the harness and the mechanical system that tracks the person; it could be a radar system, a camera vision system, or an invisible light camera vision system observing the movement of the person.

Additionally, a system for mixed reality may provide real world implements to supply an augmented reality to a user, such implements including, but not limited to, mechanisms to simulate rain sprinkling on the player, wind blowing at them, a rope dangling as if a helicopter is above the player, the noise of the helicopter, etc.

According to a preferred embodiment, a system for enhanced, multiplayer mixed reality experience comprising: a high-speed video content rendering engine stored in a memory of and operating on a processor of a computing device and configured to: retrieve a plurality of virtual reality video content data from a plurality of sources, render the virtual reality video content data at high frame rate and with minimal latency, create a memory map of rendered virtual reality video content data with very high access rate and very low latency. A high-speed virtual reality distribution module in a memory of and operating on a processor of a computing device and configured to: read the memory map, format the memory map data for best processing by a virtual reality content display client, send formatted virtual reality content to a plurality of virtual reality content display clients, perform predictive analytics functions on normalized insurance related data. An enhanced effects platform for mixed reality content data configured to: read clues for events present in the virtual reality content data, provide physical props, actions, or sounds based upon current clue to enhance a virtual reality experience beyond that of video content only.

According to another aspect, a system for enhanced, multiplayer mixed reality experience has been devised and reduced to practice. Wherein the memory map created from at least a portion of the virtual reality data will be divided into two or more memory sub-maps corresponding to point of view scene sub-sections by the high-speed virtual reality distribution module. Wherein the virtual reality content display client is at least one server computer driving virtual reality content data display on at least one virtual reality goggle. Wherein at least a portion of the virtual reality content display clients are virtual reality goggles. Wherein at least one the enhanced effects actions is air movement simulating a helicopter's down draft. Wherein at least one the enhanced effects props is the lower end of an overhead ladder.

According to a preferred embodiment, a method for the enhanced, multiplayer mixed reality experience comprising the steps of: a) retrieving a plurality of virtual reality video content data from a plurality of sources using a high-speed video content rendering engine stored in a memory of and operating on a processor of a computing device; b) rendering the virtual reality video content data at high frame rate and with minimal latency using the high-speed video content rendering engine; c) creating a memory map of rendered virtual reality video content data with very high access rate and very low latency using the high-speed video content rendering engine; d) distributing the virtual reality video content, encoded for best speed processing and display, to a plurality of virtual reality display clients using a high-speed virtual reality distribution module in a memory of and operating on a processor of a computing device; e) providing enhanced effects to correspond to clues contained in the virtual reality video content data using an enhanced effects platform for virtual reality content data;

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a diagram of an exemplary architecture of a system for an enhanced, multiplayer mixed reality experience, according to an embodiment.

FIG. 2 is a flow diagram of an exemplary method for an enhanced, multiplayer mixed reality experience.

FIG. 3 is a process diagram showing a system for fusing physical, virtual, and augmented worlds in a mixed reality player experience, per one aspect of the system and method disclosed herein.

FIG. 4 is a diagram of an exemplary architecture of a system of safety and augmented effects rigs as per one embodiment.

FIG. 5 is a block diagram illustrating an exemplary hardware architecture of a computing device used in various embodiments of the invention.

FIG. 6 is a block diagram illustrating an exemplary logical architecture for a client device, according to various embodiments of the invention.

FIG. 7 is a block diagram illustrating an exemplary architectural arrangement of clients, servers, and external services, according to various embodiments of the invention.

FIG. 8 is another block diagram illustrating an exemplary hardware architecture of a computing device used in various embodiments of the invention.

### DETAILED DESCRIPTION

The inventor has conceived, and reduced to practice, a system for enhanced, multiplayer mixed reality experience.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring sequentially (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself

Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

As used herein, “mixed reality” means any combination of virtual reality and augmented reality; that is, a set of “virtual reality goggles” used by a player would provide a mixed reality entertainment experience (the player views virtual reality but also senses “real” reality. Specifically, the term “mixed reality” is intended to be inclusive of any enhanced reality techniques, including any combination of virtual reality, augmented reality, or mixed reality, as these terms are used in the art.

### Conceptual Architecture

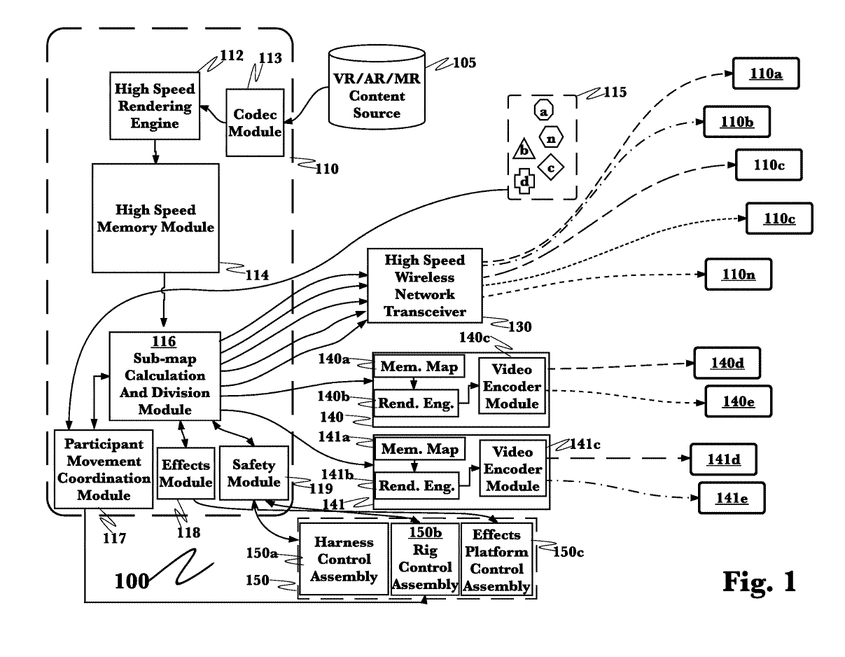

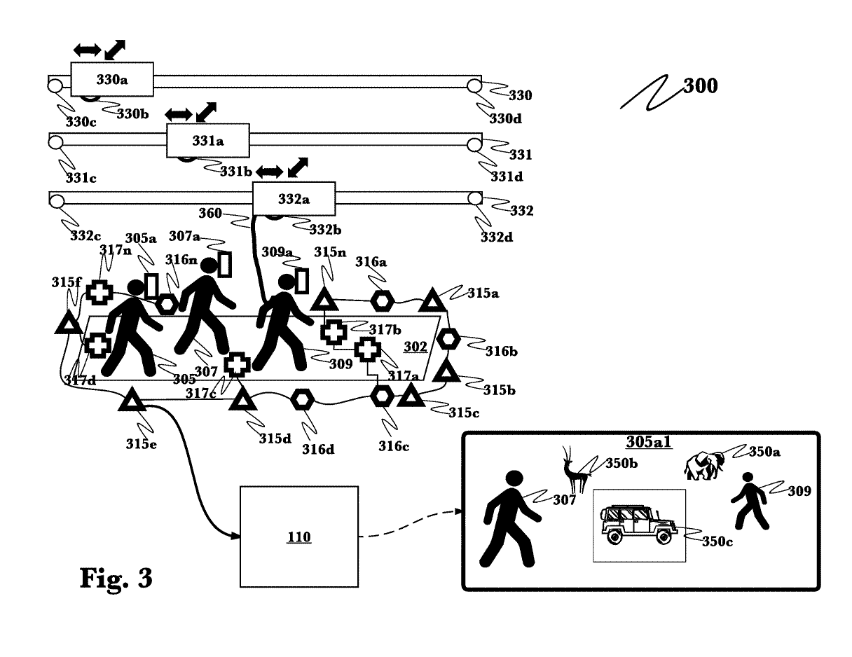

FIG. 1 is a diagram of an exemplary architecture 100 of a system for an enhanced, multiplayer mixed reality experience, according to an embodiment. Virtual reality (VR), augmented reality (AR) and mixed reality (MR) content may be retrieved from an external source 105 that may be a database of media, a content service, or another source known to those with ordinary skill in the art. The media stream, whether it be for VR, AR or MR presentation, enters the system's high-speed content rendering and distribution server 110, which is specifically designed with high-speed video rendering processors 112, large amount of high-speed video optimized memory 114, memory controllers and busses to allow the processing of 112, 116 and display 116 of complex video on up to ten or more displays 110a through 110n, 140d, 140e, 141d, 141e. In this process the media content stream retrieved from the content source 105 may first be decompressed and decoded by a dedicated high-speed module 113 and then passed to an optimized high-speed rendering engine 112 possessing a very high-speed video processor and tightly coupled high-speed bus connected module possessing enough high-speed video RAM to represent an entire VR, AR overlay, or MR mixed object type landscape in a single memory map 114. When participation in certain VR, AR, or MR interactive media types, this landscape may comprise multiple participant point of view landscapes, what a single participant may experience at his position of the VR, AR or MR presentation (see FIG. 3: 305a), within the whole. The embodiment may therefore use a specialized set of high-speed processors, including video processors, task specific and optimized programming, venue installed sensors 115 and high-speed video memory to create a module 116 that may intelligently calculate the point of views of multiple content participants (for example: FIG. 3: 305, 307, 309), divide the whole landscape into point of view specific portions and encode the new content into that to allow display by the client device which may be directly to VR goggles 110a through 110n possibly through a high-speed wireless network connection 130. Alternately, the VR, AR, or MR video signal may be sent to one or more general purpose servers 140, 141 each possibly with off the shelf level graphics processors 140b, 141b, average range memory allotments 140a, 141a and video converters 140c, 141c. These intermediary servers may be expected to drive one or two VR goggles 140d, 140e, 141d, 141e with high frame rate and low inter-ocular latency such that participants enjoy the content experience.

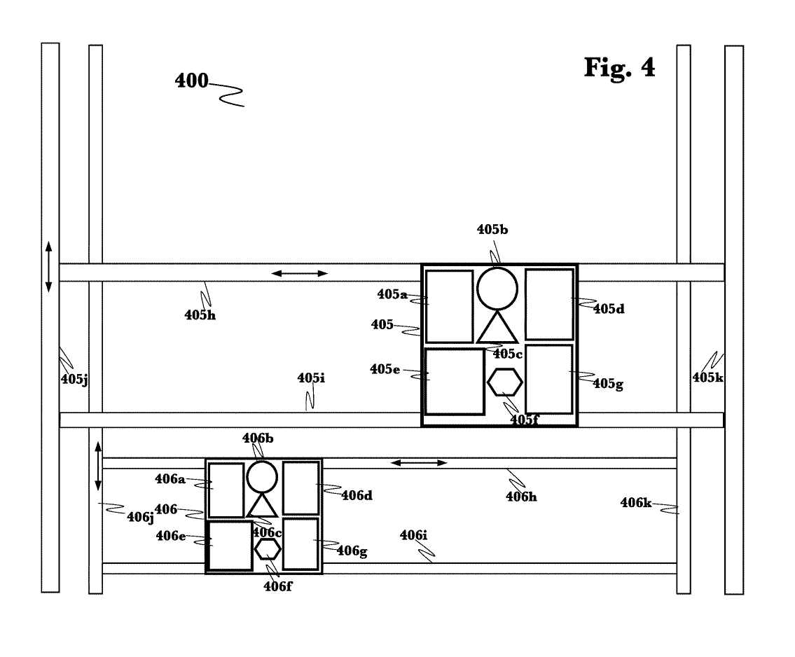

In addition to high frame rate, low latency VR, AR or MR content display, which may also be individualized for each participant's point of view, the embodiment may further the visual experience by providing other effects called for by the content. For example, one action/adventure title may have the participants pass by a large waterfall, the embodiment may then mist the participants near the waterfall to simulate the experience. In the same or similar game, participants may jump onto a ladder from and overhead helicopter. In this scenario, the embodiment may create a down draft and lower the bottom rungs of a ladder from a movable overhead utility station 150 (see also FIG. 3: 330a, 331a, 332a and FIG. 4: 405, 406) such that the participants may better experience the adventure scene. Many other examples of ways such capabilities may be used to augment VR, AR or MR content in the setting of a wide variety of content types and genres may be imagined to those skilled in the art. These few descriptions are meant only to briefly illustrate the use and should not be construed in any way to limit the breath of utility of embodiments in this area. These effects capabilities make use of sensors of a plurality of types and uses 115a, 115b, 115c, 115d, 115n to track participant movements in real time within the VR, AR, or MR presentation venue and translate those movements into movements within the content being presented 117. Some of these sensors may measure humidity and temperature 115 in various areas of the venue. Still others may track participant movements of specific types to predict possible fall behavior or other participant well-being parameters available to improve the safety of participants' experiences 119. For certain content, using as an example cliff climbing simulations or content sessions involving participants of special needs, harnesses may be connected to the overhead utility rigs or some similar secure platform that may follow above each user 150 or small group of users such that detection of a fall occurring may lead to enough harness support being applied through a harness control assembly 150a on the overhead utility rig 150, 330a, 331a, 332a, 405, 406 and for a period to allow the involved participant to regain her stability without injuring themselves or others. While harnesses may, in some cases, reduce the posigrade, retrograde and lateral motion of one or more participants during the VR, AR or MR presentations due to the risk of line entanglements, harnesses may be used at any time under aspects of the system. Sensor feedback also allows playback of the presentation content to be correctly timed 116, The timely use of effects 118, 150c and the correct positioning of the overhead utility rig is also controlled by sensor feedback 119, 150b.

While the illustrated embodiment appears to depict the entire system created in a single server unit, the capabilities disclosed above may also be carried out in a cluster of servers communicating of ultrafast dedicated network connections as well as similar configurations familiar to those skilled in the art.

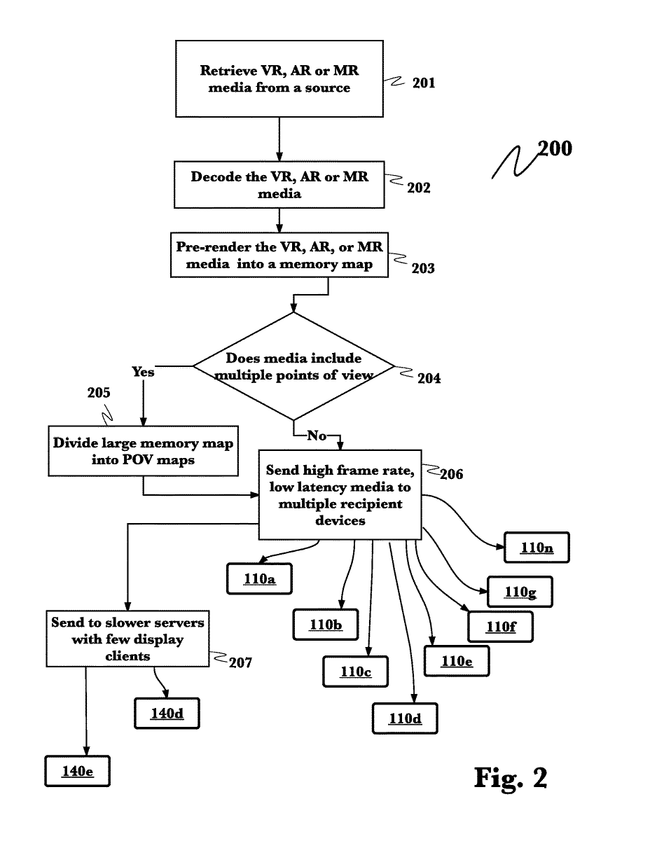

FIG. 2 is a flow diagram of an exemplary method for an enhanced, multiplayer mixed reality experience 200 per one aspect of the system disclosed herein. VR, AR or MR related content is retrieved from a source which may include a local database, a networked database or a content service from which the title of interest may be downloaded by methods allowing presentation 201. This content, regardless of source, may be decompressed and decoded to format rendered by the embodiment 110 prior to rendering 202. The content is then rendered into a memory map of the entire VR, AR or MR landscape on a server or server cluster possessing high-speed video processors, high-speed video optimized memory sufficient to store the amount of video data present and task optimized specific programming to allow the supply of 10 or more individual video clients displays 203. The content may encompass a scene expansive enough, or the conditions of the VR, AR or MR experience may dictate that two or more-separate point of view sub-maps of the whole landscape be generated to afford most efficient use of downstream less video capable devices 204. If this is the case, the embodiment may calculate and generate sub-maps divided into point of view sub-scenes throughout the time length experience 205. The resultant high frame rate low latency rendered media 206 may then be sent directly to a plurality of display devices often VR type goggles 110a through 110n or sent to a plurality possibly less capable downstream servers 207 each driving a lesser number of VR goggle display clients 140d, 140e.

FIG. 3 is a process diagram showing a system for fusing physical, virtual, and augmented worlds in a player experience 300, per one aspect of the system and method disclosed herein. Participants 305, 307, 309 in a VR, AR or MR presentation may experience such a presentation whether it be a game, a simulation, or an enhanced format tour, perhaps theatrical video, just to name a limited number of examples among the plurality familiar to those skilled in the art, at a specially designed or modified venue 302. This venue may be equipped with multiple examples of both sensors with different sensing capabilities and functions within a VR, AR or MR presentation embodiment 315a-n, 316a-n, 317a-n, and multiple instances of the same sensor placed in multiple positions within and around the periphery of the venue 315a, 315b, 315c, 315d, 315e, 315n; 316a, 316b, 316c, 316d, 316n; 317a, 317b, 317c, 317d, 317n. These sensors may allow a plurality of parameters, including but not limited, to participant location, participant movement direction and movement speed, localized lighting levels, temperature and humidity levels at specific locations of the venue, and possibly participant safety information such as potential for a fall, rapid respiration, and heart rate. The participants may each be wearing a pair of embodiment connected VR type goggles 305a, 307a, 309a, which may also include sound feeds and may thus be immersed in both the visible and auditory components of the VR, AR, or MR presentation. To enhance the experience, each participant may be serviced by an overhead utility rig 330a, 331a, 332a which by use of integral sensors 330b, 331b, 332b or some combination of integral and participant level sensors 315a-n, 316a-n, 317a-n to remain above the participant it may be providing effects enhancement such as prop-ends such as possible ladder ends, rope ends, mist, rain, wind, heat and many other possible effects imaginable by those skilled in the art. The overhead utility rig 332a may also provide such safety measures as an intelligent harness 360 which may activate when one or more sensors detect that a fall of one of the participants equipped is imminent to provide the support needed to assist the participant in stabilizing herself, preventing the fall. Sensor input serves to assist in coordination of all aspects of the VR, AR, and MR by the embodiment 110 which may combine avatars, partial avatars or real time representations of other participants 307, 309, and content generated props 350a, 350b, 350c in each participant's 305 VR goggles 305a, 305a1. Overhead utility rigs are able to move with participants through use of sets of motorized rails spanning both the X 330, 331, 332 and Y axes 330c,d, 331c,d, 332c,d. Independent, unimpeded movement of each overhead utility rig may be allowed by mounting each rig at a different vertical level.

Under certain conditions and where some or all participants agree to sharing, the VR, AR or MR video feeds of one or more of those participants in a session may be provided to a group of one or more observers who may follow the virtual action of the session participants. This may be used to acclimate novice users to a complex simulation of interest or necessity, in the case of educational uses, to them or to allow those who might not be able to otherwise participate to experience the VR session, among other uses of such an observer system familiar to those skilled in the art.

FIG. 4 is a diagram of an exemplary architecture of a system of safety and augmented effects rigs 400 as per one embodiment. Shown are two example embodiments of an overhead utility rig 405, 406 as seen from above. Both attach to the walls of the venue on a set of two or more rails 405j, 405k; 406j, 406k depending on weight support requirements. These rails are placed on the wall supports at varying heights such that each rig has full, unimpeded movement without interference from other rigs, unless harnesses are in use resulting in each rig having a cable from it connecting to a presentation participant in which case programming from the harness controlling safety module (FIG. 1, 119) prevents participants with harnesses from fouling them with other utility rig rigging or other participants. Lateral movement may be controlled by a second set of rails 405h, 405i; 406h, 406i that extend at 90 degree angles to the wall mounted rails and pass overhead of the participants. Each overhead utility rig may include motors to enable forward and retrograde movement 405a, 406a and lateral movement 405g, 406g both under control of the VR/AR/MR presentation server 110; a harness control motor, active only when harnesses are in use 405e, 406e; one or more extended effects modules 405b, 406b, 405c, 406c, 405d, 406d which may include fans to produce wind-like effects, heaters to simulate fire, the distal ends of a plurality of props such as overhead ladders, overhead ropes, and vines; misters and sprinkler heads to simulate mist as might be found at a waterfall or drizzle, fog or rain just to name a subset of possible effect possibilities from a larger set of available options. The rig may also carry one or more sensors of various types 405f, 406f which may help it track VR, AR, or MR presentation participants, especially the one to which it may be assigned, or may serve one of a plurality of other purposes.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

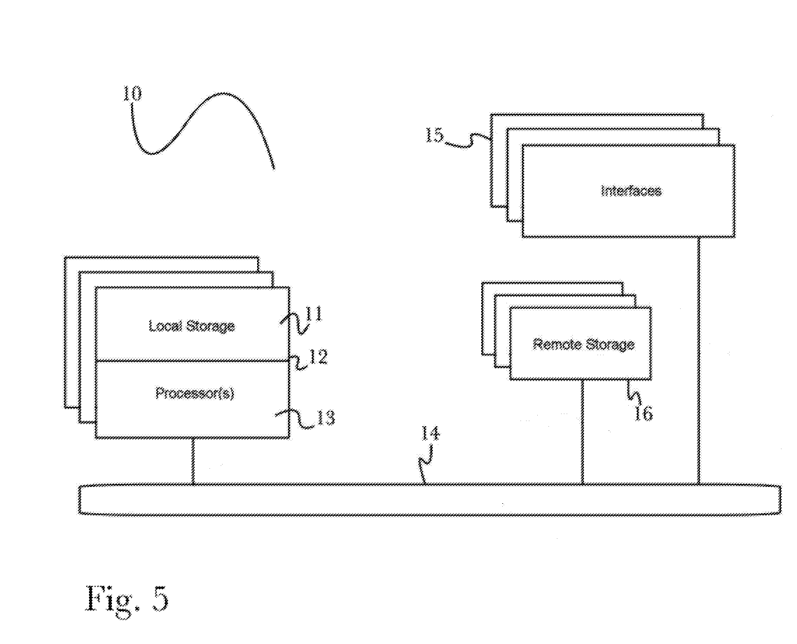

Referring now to FIG. 5, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 5 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

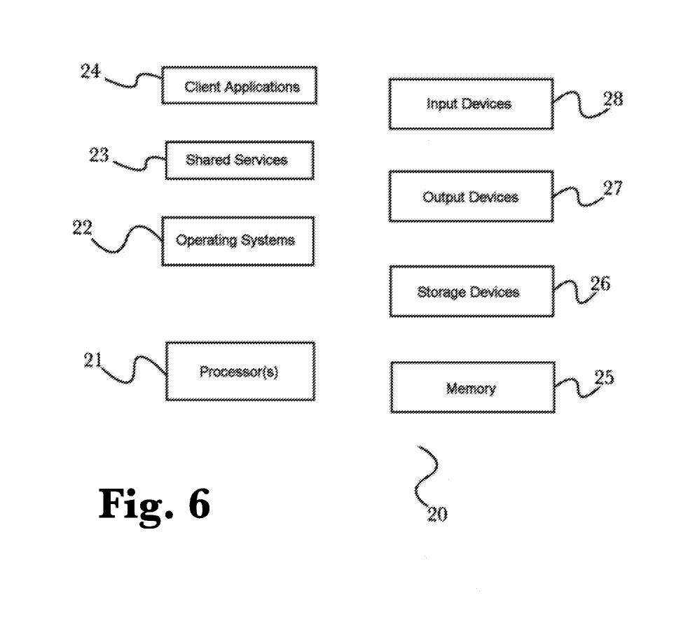

In some embodiments, systems according to the present invention may be implemented on a standalone computing system. Referring now to FIG. 6, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

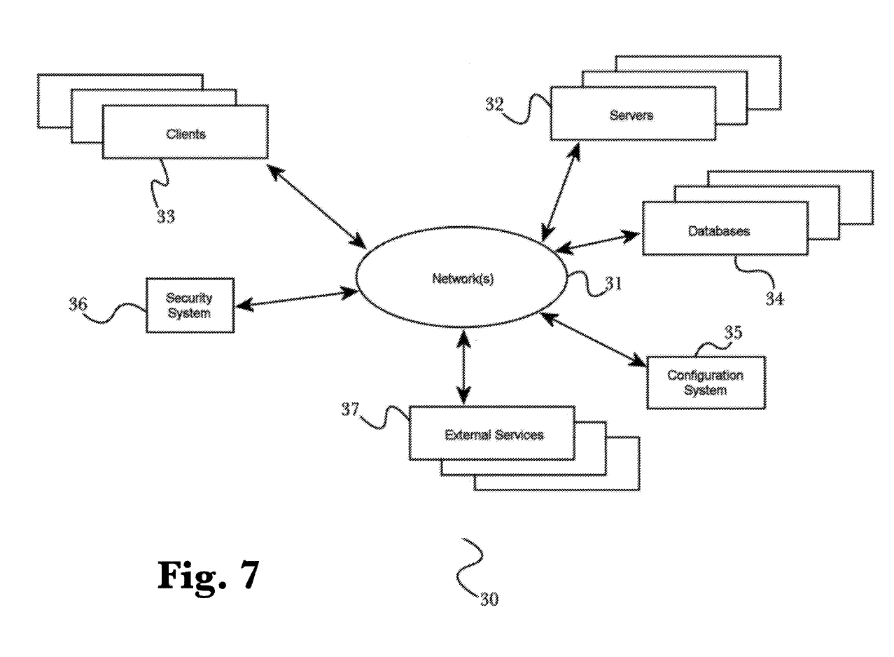

In some embodiments, systems of the present invention may be implemented on a distributed computing network, such as one having any number of clients and/or servers. Referring now to FIG. 7, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 6. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

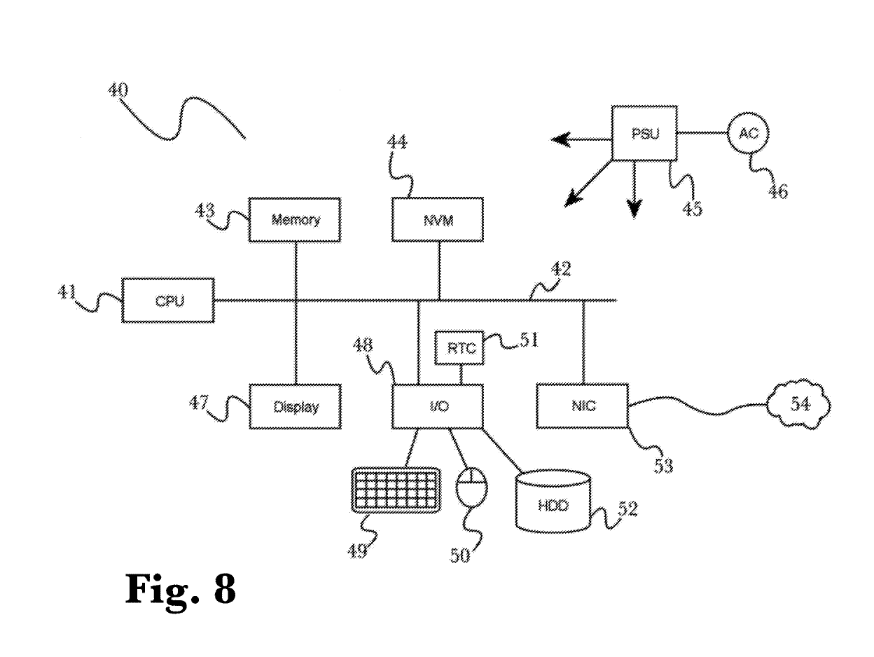

FIG. 8 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

According to a preferred embodiment, a system for enhanced, multiplayer mixed reality experience is disclosed, comprising: a high-speed video content rendering engine stored in a memory of and operating on a processor of a computing device and configured to: retrieve a plurality of mixed reality video content data from a plurality of sources; render the mixed reality video content data at high frame rate and with minimal latency; create a memory map of rendered mixed reality video content data with very high access rate and very low latency; a high-speed mixed reality distribution module in a memory of and operating on a processor of a computing device and configured to: read the memory map; format the memory map data for best processing by a mixed reality content display client; send formatted virtual reality content to a plurality of mixed reality content display clients; perform predictive analytics functions on normalized insurance related data; and an enhanced effects platform for mixed reality content data configured to: read clues for events present in the mixed reality content data; provide physical props, actions, or sounds based upon current clue to enhance a mixed reality experience beyond that of video content only.

According to another embodiment, the memory map created from at least a portion of the mixed reality data will be divided into two or more memory sub-maps corresponding to point of view scene sub-sections by the high-speed mixed reality distribution module. In another embodiment, the mixed reality content display client is at least one server computer driving mixed reality content data display on at least one mixed reality goggle. In yet another embodiment, at least a portion of the mixed reality content display clients are virtual reality goggles. According to a further embodiment, at least one the enhanced effects actions is air movement simulating a helicopter's down draft. In another embodiment, at least one the enhanced effects props is the lower end of an overhead ladder.

According to another preferred embodiment, a method for an enhanced, multiplayer mixed reality experience is disclosed, comprising the steps of: a) retrieving a plurality of mixed reality video content data from a plurality of sources using a high-speed video content rendering engine stored in a memory of and operating on a processor of a computing device; b) rendering the mixed reality video content data at high frame rate and with minimal latency using the high-speed video content rendering engine; c) creating a memory map of rendered mixed reality video content data with very high access rate and very low latency using the high-speed video content rendering engine; d) distributing the mixed reality video content, encoded for best speed processing and display to a plurality of mixed reality display clients using a high-speed mixed reality distribution module in a memory of and operating on a processor of a computing device; and e) providing enhanced effects to correspond to clues contained in the mixed reality video content data using an enhanced effects platform for mixed reality content data.

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for enhanced, multiplayer mixed reality experience comprising:
a high-speed video content rendering engine stored in a memory of and operating on a processor of a computing device and configured to:
retrieve a plurality of mixed reality video content data from a plurality of sources;
render the mixed reality video content data at high frame rate and with minimal latency;
create a memory map of rendered mixed reality video content data with very high access rate and very low latency;
a high-speed mixed reality distribution module in a memory of and operating on a processor of a computing device and configured to:
read the memory map;
format the memory map data for best processing by a mixed reality content display client;
send formatted virtual reality content to a plurality of mixed reality content display clients;
perform predictive analytics functions on normalized insurance related data; and
an enhanced effects platform for mixed reality content data configured to:
read clues for events present in the mixed reality content data;
provide physical props, actions, or sounds based upon current clue to enhance a mixed reality experience beyond that of video content only.

2. The system of claim 1, wherein the memory map created from at least a portion of the mixed reality data will be divided into two or more memory sub-maps corresponding to point of view scene sub-sections by the high-speed mixed reality distribution module.

3. The system of claim 1, wherein the mixed reality content display client is at least one server computer driving mixed reality content data display on at least one mixed reality goggle.

4. The system of claim 1, wherein at least a portion of the mixed reality content display clients are virtual reality goggles.

5. The system of claim 1, wherein at least one the enhanced effects actions is air movement simulating a helicopter's down draft.

6. The system of claim 1, wherein at least one the enhanced effects props is the lower end of an overhead ladder.

7. A method for an enhanced, multiplayer mixed reality experience comprising the steps of:
a) retrieving a plurality of mixed reality video content data from a plurality of sources using a high-speed video content rendering engine stored in a memory of and operating on a processor of a computing device;
b) rendering the mixed reality video content data at high frame rate and with minimal latency using the high-speed video content rendering engine;
c) creating a memory map of rendered mixed reality video content data with very high access rate and very low latency using the high-speed video content rendering engine;
d) distributing the mixed reality video content, encoded for best speed processing and display to a plurality of mixed reality display clients using a high-speed mixed reality distribution module in a memory of and operating on a processor of a computing device; and
e) providing enhanced effects to correspond to clues contained in the mixed reality video content data using an enhanced effects platform for mixed reality content data.

8. The method of claim 7, wherein the memory map created from at least a portion of the mixed reality data will be divided into two or more memory sub-maps corresponding to point of view scene sub-sections by the high-speed mixed reality distribution module.

9. The method of claim 7, wherein the mixed reality content display client is at least one server computer driving mixed reality content data display on at least one virtual reality goggle.

10. The system of claim 7, wherein at least a portion of the mixed reality content display clients are virtual reality goggles.

11. The system of claim 7, wherein at least one the enhanced effects actions is air movement simulating a helicopter's down draft.

12. The system of claim 7, wherein at least one the enhanced effects props is the lower end of an overhead ladder.
